(19) United States
(12) Patent Application Publication
(10) Pub. No.: US 2006/0212150 A1
(43) Pub. Date: Sep. 21, 2006

(54) Method of providing 3D models

(76) Inventor: William Sims JR., Chopin, SC (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/340,053

(22) Filed: Jan. 26, 2006

Related U.S. Application Data
(60) Provisional application No. 60/654,352, filed on Feb. 18, 2005.

(51) Int. Cl. G06F 19/00

(52) U.S. Cl. 700/98

(57) ABSTRACT

A novel method for providing a customized 3D model is disclosed. The novel method includes providing a means for a user to request a customized 3D model; generating the customized 3D model for the user; and delivering the customized 3D model to the user.

### CROSS REFERENCED TO RELATED APPLICATIONS

This application claims the benefit of U.S. Provisional Patent Application Ser. No. 60/654,352, filed on Feb. 18, 2005, which is incorporated herein in its entirety.

### FIELD OF THE INVENTION

The present invention is directed toward the field of 3D imaging and modeling. In particular, the present invention is directed toward a business method that would allow kids and hobbyists to custom build models in a simple 3D CAD environment and then subsequently print them using STL and other 3d extrusion techniques. The customer will then leave with a unique model that he or she designed. The customer can select from a variety of existing models to customize the way he wants, or can submit photos of his own to have a unique model generated.

### BACKGROUND OF THE INVENTION

A number of patents have issued directed to the area of 3D imaging and modeling. U.S. Pat. No. 5,945,996 is directed to a system and method for the rapid creation of a mesh model depicting a real world object, terrain or other three-dimensional surface. The system inserts points into the mesh incrementally, building the mesh point by point. Before incremental building, the system orders the points so that each next point is a near neighbor to the previously inserted point. This ordering procedure optimizes mesh construction by guaranteeing a minimal time for locating the area on the mesh into which the next point will be inserted. The present invention also provides a system and method to ensure an optimal quality of mesh at any level of insertion or deletion, following systematized checking function to maintain quality such as that required in Delaunay triangulation. The system and method can also incorporate a history file to store data concerning the results of the checking to substantially reduce processing time in mesh regeneration applications.

U.S. Pat. No. 6,204,850 is directed to a computer implemented system and method provide navigation of information structures through corresponding graphical structures containing graphical nodes. Each graphical node has its own bounded volume defined in a relative 3D coordinate space. Each graphical node further may have a parent or child containment relationship with any other arbitrary graphical node. The containment relationships correspond to semantic containment relationships of corresponding information nodes in an information structure. As a result, the various 3D coordinate spaces are arbitrarily nested within each other, yet provide for a fully defined local coordinate frame of reference for contained objects. A viewer module manages a view volume in the coordinate space of a current one of the graphical nodes and associated current coordinate space. As the user moves a viewpoint in the current coordinate space, the view volume is dynamically rescaled in inverse proportion to the depth of the viewpoint in that space. The viewer module then dynamically selects for display only those child graphical nodes that have coordinate extents intersecting the rescaled view volume. The viewer module further allows navigation of the viewpoint from the coordinate space of a parent graphical node into the coordinate space of any of its child graphical nodes, representing a narrowing of a semantic scope within the information structure, and the reverse representing a broadening of semantic scope. A rate of change in the location of the viewpoint in the current coordinate space may be made proportional to the distance of the viewpoint from the rear plane of that bounded volume, preventing the viewpoint from ever reaching the rear plane, and providing a sensation of travel within a space of infinite depth.

U.S. Pat. No. 6,456,287 is directed to a method in accordance with the invention comprising the step of providing a) pixel array and a computer model of a geometric surface, and b) providing a second array (a Z array) containing information concerning the 3D characteristics of the structure depicted in the pixel array. The Z array is used to modify the location of the geometric surface. The pixel array and modified geometric surface are then used to render an image that can be displayed on a CRT or other output device. By modifying the geometric surface model in this way, it is possible to create more realistic images.

U.S. Patent Application No. 2003/0117392 is directed to an automatic 3D modeling system and method are described in which a 3D model may be generated from a picture or other image. For example, a 3D model for a face of a person may be automatically generated. The system and method also permits gestures/behaviors associated with a 3D model to automatically generated so that the gestures/behaviors may be applied to any 3D models.

### OBJECTS AND SUMMARY OF THE INVENTION

It is an object of the present invention to provide a method for allowing a user to have a customized 3D model generated from a request.

It is a further object of the present invention to provide a method for allowing a user to have a 3D model generated from a request including the steps of: providing a means for a user to request a customized 3D model; generating the customized 3D model for the user; and delivering the customized 3D model to the user.

It is yet a further object of the present invention to provide a method for allowing a user to have a 3D model generated from a request wherein the user can finish the customized 3D model on his own.

In accordance with a first aspect of the present invention, a novel method for allowing a user to have a 3D model generated from a request is provided. The novel method includes providing a means for a user to request a customized 3D model; generating the customized 3D model for the user; and delivering the customized 3D model to the user.

In accordance with another aspect of the present invention, a novel method for allowing a user to receive a 3D model generated from a request where the user can finish his model is provided.

### BRIEF DESCRIPTION OF THE DRAWINGS

The foregoing summary, as well as the following detailed description of a preferred embodiment of the present invention will be better understood when read with reference to the appended drawings, wherein:

FIG. 1 is a flow diagram depicting a typical process for a user to receive a 3D model from a request.

FIG. 2 is a flow diagram depicting a method for a user to receive a 3D model from a request from a mall kiosk.

FIG. 3 is a flow diagram depicting a method for a user to receive a 3D model from a request from an internet website.

### DETAILED DESCRIPTION OF THE PREFERRED EMBODIMENT

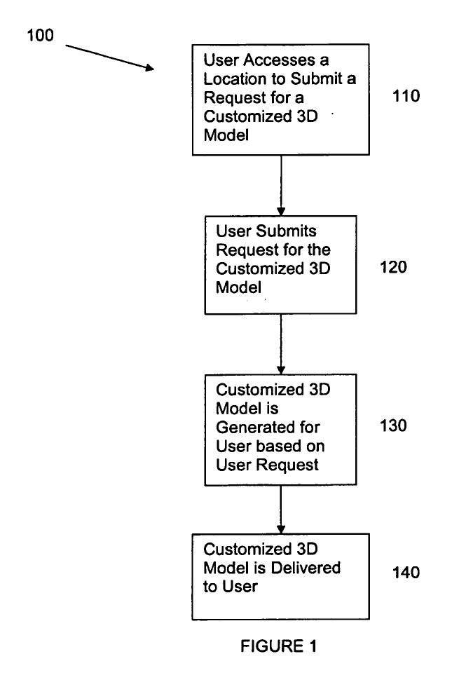

Referring now to the drawings, wherein like reference numerals refer to the same components across the several views and in particular to FIGS. 1, 2 and 3, there is shown a method for providing a customized 3D model to a user 100.

Referring now to FIG. 1, the method for providing a customized 3D model to a user 100 begins when the user accesses a location to submit his request 110. In step 120, the user submits a request for a 3D model to be generated. The request can include the submission of a photograph, CAD drawing, or other similar submission. Additionally, the user can pick from a pre-existing series of models and customize them to his desire. For example, the user may select a model from a line of airplanes that the user wants to generate a 3D model for, and may customize the color, and other appearances that the user may desire. In step 130, the 3D model is generated for the user. In a preferred embodiment of the present invention, the 3D model is generated using STL or other 3D extrusion techniques known to one of ordinary skill in the art. In a preferred embodiment of the present invention, customized 3D models are provided, however, additionally, other custom made items may be generated for the user, such as plates, coffee mugs, and molds for objects to be cast out of resin, metal and ceramics.

In step 140, the customized 3D model is delivered to the user. The delivery can take place by a variety of methods. For example, in one embodiment of the present invention, the delivery of the customized 3D model can be shipped directly to the user, or shipped to a location the user chooses when requesting the customized 3D model. For example, the user can request the 3D model be delivered to a kiosk at a mall, where the user can retrieve the customized 3D model.

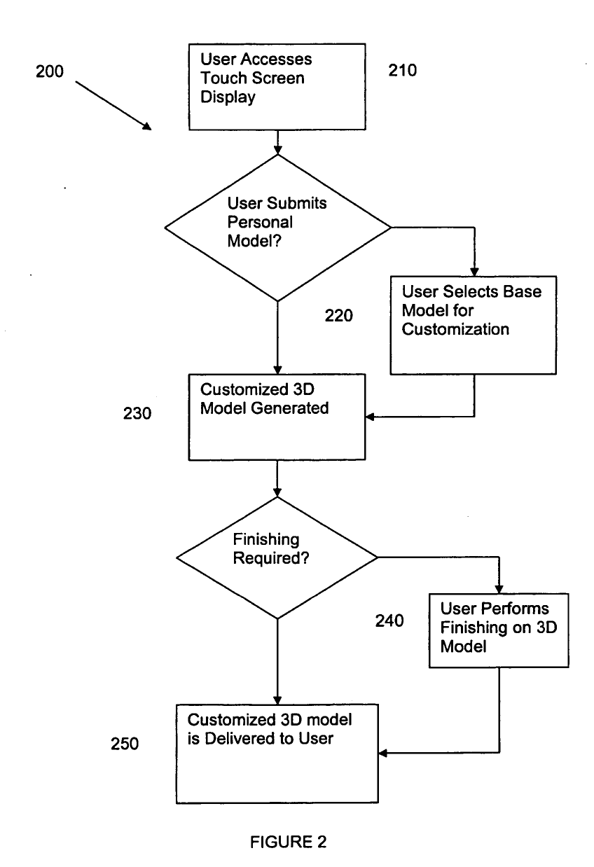

Referring now to FIG. 2, a method for providing a customized 3D model to a user at a mall kiosk 200 is depicted. The user would access a touch screen display at the mall kiosk 210. The touch screen display would provide a number of different base level models from which the user could choose to customize, or the user can submit a model to be generated. If the user selects one of the pre-existing base models, then the user can select customizable features from the base level model in step 220, and a customized 3D model will be generated for the user in step 230. In addition to selecting a base level model to customize, the user could submit photographs, or other drawings and the like to have a customized 3D model generated based on the user's submission. For example, the user could submit a picture of his or her child, pet, car, or other object, and have a 3D model generated for the user based on that submission.

Or, the user may have a system to scan his child, pet, car, face, and the like and incorporate this into the custom 3D model. Furthermore, the user may manipulate and modify the model to further shape and customize it to his liking, Including having his/her face or the face of a pet or relative incorporated into a pre-existing model of a video game or movie/tv show character or object, such as The Hulk, Mickey Mouse, etc.

Additionally, the user can select video game characters, or objects from movies which can be selected, customized, and re-created onsite in the presence of the customer who will purchase it.

The customized 3D model can be generated using any means known to one of ordinary skill in the art. For example, CNC, STL or other 3D extrusion techniques are typical techniques utilized, however any means known to one of ordinary skill in the art may be employed. An opportunity for the user to apply finishing touches to the customized 3D model is provided at the mall kiosk in step 240. The finishing can take the form of sanding, painting, and the like. The user takes delivery of the customized 3D model in step 250.

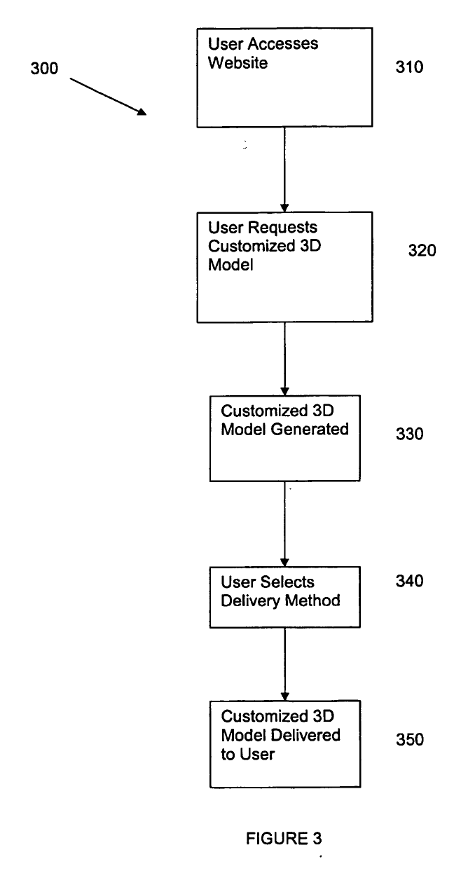

Referring now to FIG. 3, a method for providing a customized 3D model to a user via an internet website 300 is shown. In step 310, the user accesses the website provided. In step 320, the user submits a request for a customized 3D model either by selecting a base model provided on the website or by submitting a photograph, drawing, or other document to have a customized 3D model generated from the submission. The customized 3D model is then generated for the user in step 330 using STL, 3D extraction techniques, or any other means for generating a 3D model known to one of ordinary skill in the art. In step 340, the user selects the method by which he wants his customized 3D model delivered to him, and in step 350, the customized 3D model is delivered to the user as requested. In particular, the user might select the customized 3D model to be delivered to him at any location he specifies, or may select to have the customized 3D model delivered to a mall kiosk for him to pick up later. In view of the foregoing disclosure, some advantages of the present invention can be seen. For example, a novel method for providing a customized 3D model to a user is provided. The novel method allows for a user to have a customized 3D model generated from a request either to a website or at another physical location, and put finishing touches on the model as the user desires. For example, the 3D model can be finished by heating in an oven so as to bond the materials together forming a nylon like plastic finish.

In an additional embodiment of the present invention, a user can select 3d designs of homes or buildings and then using a spray technology mounted on a computer controlled track to print layers of concrete, fiberglass, polystyrene, woodparticles, resin, and polymer materials which would form a 3d structure that could be used as a house or building. Alternatively, dry materials could be fused together using a laser or a fluid binder so as to accomplish the same 3d structure. this technique would be used for creation of larger gizmo parts/models such as statues, houses, and the like. The spray technology would be unique in that it would function via a computer controlled spray device which would lay down strata and layers of material which could be hardened and solidified to form a home or building.

Additionally, a kiosk with touchscreen can be located in retail locations that will display a catalog of 3d modeled objects which a user can choose from, modify, and then order a custom made part. Similarly, a software program can be provided that displays a catalog of 3d CAD files in STL or VRML STL format which can be viewed by a user for selection and production as an actual replica.

The user can also manipulate a control device to create and model and object on screen, which can be printed and/or extruded for them. In this fashion, the user can get tactile feedback as they model the object in cyberspace.

The website or computer program will offer VRML, STL color files such that the customer can select a number of files which can be STL printed or 3d modeled. Optionally, the customer can upload other VRML STL files that may include 3d images built by the customer, 3d scans of a pet, person, or object known to the customer, and these parts can be printed.

Once printed, the parts may be finished by the customer or by the staff of Gizmo store, including infiltration, sanding, adding bondo, painting. Lastly, the parts will be assembled by the client to create a unique model of the customer's design.

The customer will have the option of designing and finishing his part onsite at a retail location such as a mall kiosk or other kiosk (at amusement parks, tourist areas) or the customer may design his part at home via the Internet and elect to finish, sand, infiltrate his model either onsite or at home.

In an additional embodiment of the present invention, the 3d model generation can be applied to movies and video games. For example, in a video game, a person will see an icon or symbol above certain objects in the game, such as a car, person, or other object. They will be able to select this object, preferably by “shooting” the object in the game, and the object will be saved or frozen and placed in an online “souvenir store.” At the end of play, the person visits the “souvenir store” and can order that object and have it shipped to them or prepared for pickup at a retail store. Additionally, the user could select the object by clinging on the object in a virtual world. For example, a user could travel around a virtual planet earth and could locate virtual “souvenir stores” wherein he could purchase 3D objects that bear emotional/souvenir relationships to the area visited during the virtual travel. This 3D object could be produced and sent to the user. The user could also choose to have his/her face or the face of a pet or relative incorporated into a pre-existing model of a video game or movie/tv show character or object, such as The Hulk, Mickey Mouse, etc.

For a movie, the viewer will have a small identifier code number on the screen, preferably in the lower right corner, and will be able to select the code, preferably by pressing a key such as the “ENTER” key when the code is displayed. In a movie theater, this could be achieved by having the viewer use a handheld remote device. For a DVD movie, the viewer may press the “ENTER” key on the player itself or on the remote device for the player. Additionally, there could be a “souvenir store” with movie collectables added as an extra on the DVD itself. After the viewer selects his or her objects, he can order it via the internet or other means, such as calling a toll free number. The object will be modeled and sent to the viewer or prepared for pickup at a retail store.

While the preferred embodiment of the present invention has been described and illustrated, modifications may be made by one of ordinary skill in the art without departing from the scope and spirit of the invention as defined in the appended claims. For example, a mall kiosk has been described in a preferred embodiment as a location for a user to go to have a customized 3D model generated, however, any location known to one of ordinary skill in the art will suffice. For instance, the location could be a toy store, department store, or any other facility to which the user could travel. Additionally, in a preferred embodiment of the present invention, a three dimensional scanning system such as one commercially known as CRYSTAL MAGIC, which can scan and render an image into a 3D CAD program. In addition to painting and sanding as part of finishing, the finishing can also include offering chrome, metal, or other plating of the customized 3D models and objects so as to harden them from damage, and to improve their appearance on site. However, other finishing known to one of ordinary skill in the art may be included.

What is claimed is:

1. A method for providing 3D models, comprising the steps of:
providing a means for a user to request a customized 3D model;
generating the customized 3D model for the user; and
delivering the customized 3D model to the user.

2. The method of claim 1, wherein the user requests the customized 3D model at a mall kiosk.

3. The method of claim 2, wherein the 3D model is delivered to the user at the mall kiosk.

4. The method of claim 1, wherein the user requests the customized 3D model via an internet website.

5. The method of claim 4, wherein the 3D model is delivered to the user by being shipped to the user.

6. The method of claim 4, wherein the 3D model is delivered to the user at a prespecified location.

7. The method of claim 6, wherein the prespecified location is a mall kiosk.

8. A method for providing customized 3D models, comprising the steps of:
providing a touch screen panel at a mall kiosk from which a user may select a model to have a customized 3D model generated;
generating the customized 3D model based on the selection of the user; and
providing finishing for the customized 3D model.

9. The method of claim 8, wherein the finishing for the customized 3D model includes providing the user with the ability to paint the customized 3D model.

10. The method of claim 8, wherein the finishing for the customized 3D model includes providing the user with the ability to sand the customized 3D model.

11. A method for providing 3p models from a video game, comprising the steps of:
selecting an object by a user with a symbol above it in the video game;
saving the object in a virtual souvenir store;
ordering the object from the virtual souvenir store;
generating a 3D model of the object; and
delivering the 3D model of the object to the user.

12. The method of claim 11, wherein the step of selecting an object by a user is accomplished by the user virtually shooting the object on the screen.

13. The method of claim 11, wherein the step of selecting an object by a user is accomplished by the user clicking the object in a virtual world.

14. The method of claim 11, wherein the step of delivering the object to the user includes shipping the 3D model to the user directly.

15. The method of claim 11, wherein the step of delivering the object to the user includes providing the object at a location for pickup by the user.

16. A method for providing 3D models from a movie, comprising the steps of:
providing an identifier code on the screen for selection by a user;
saving an object related to the identifier code;
providing a means for the viewer to order a 3D model of the object saved; and
providing the 3D model to the viewer.
